(19) United States
(12) Patent Application Publication
(10) Pub. No.: US 2022/0282913 A1
(43) Pub. Date: Sep. 8, 2022

(54) PURIFICATION OF CARBON MONOXIDE BY CRYOGENIC DISTILLATION

(71) Applicant: L'Air Liquide, Societe Anonyme pour l'Etude et l'Exploitation des Procedes Georges Claude, Paris (FR)

(72) Inventors: Camille BOUVIER, Sassenage (FR); Golo ZICK, Sassenage (FR); Philippe FRAYSSE, Sassenage (FR); Damien TILL, Sassenage (FR)

(73) Assignee: L'Air Liquide, Societe Anonyme pour l'Etude et l'Exploitation des Procedes Georges Claude, Paris (FR)

(21) Appl. No.: 17/679,892

(22) Filed: Feb. 24, 2022

(30) Foreign Application Priority Data
Mar. 5, 2021 (FR) FR 2102156

(51) Int. Cl. F25J 3/02

(52) U.S. Cl. CPC F25J 3/0271; F25J 2205/24

(57) ABSTRACT

In a process for the separation of a flow containing at least 97% mol of carbon monoxide containing at least one lighter compound and at least one heavier compound, the flow is separated in a column and a column, one of the columns being a denitrogenation column and the other a column for purification in argon, in order to form a flow very rich in carbon monoxide.

### CROSS REFERENCE TO RELATED APPLICATIONS

This application claims the benefit of priority under 35 U.S.C. § 119 (a) and (b) to French patent application No. FR2102156, filed Mar. 5, 2021, the entire contents of which are incorporated herein by reference.

### FIELD OF THE INVENTION

The present invention relates to a process and to an apparatus for the purification of carbon monoxide. In particular, the purified product must contain between 99% mol and 99.999% mol, indeed even 99.9999% mol, of carbon monoxide.

### BACKGROUND OF THE INVENTION

The purification of carbon monoxide to produce a pure carbon monoxide containing 0.1 ppm or less of carbon dioxide and of hydrogen is described in WO18111719.

The electronics industry requires a product containing between 99% mol and 99.999% mol, indeed even 99.9999% mol, of carbon monoxide. This product must contain very little nitrogen (less than 2 ppm, indeed even less than 0.5 ppm) and/or very little argon (less than 2 ppm, indeed even less than 0.5 ppm).

The mixture to be purified contains less than 99% of carbon monoxide or less than 99.999% of carbon monoxide or less than 99.9999% of carbon monoxide, as the case may be.

It can also contain at least one of the following elements: nitrogen, argon, hydrogen, methane or oxygen.

Numerous patents exist regarding the purification of CO; however, they are generally based on the separation of one of the following mixtures: CO/H₂, CO/CH₄ or CO/N₂.

The consecutive separation of nitrogen and argon and the CO/Ar separation have not been studied in the past. On the other hand, the literature describes:
For the Ar—CO equilibrium:

Duncan A. G. and Staveley L. A. K., 1966, Trans. Faraday Soc., 62, 3, pp. 548-552, Christiansen L. J. and Fredenslund A., 1973, Cryogenics, p. 405
For the N₂—CO equilibrium:

Sprow F. B. and Prausnitz J. M., 1966, A.I.Ch.E. J., 12, 4, 780 Hirata M., Ohe S. and Nagahama K., 1975, Computer Aided Data Book of Vapor-Liquid Equilibrium, Tokyo, Kodanska Ltd., Elsevier.

### SUMMARY OF THE INVENTION

Argon, like methane, has a higher liquefaction temperature than CO (they being heavier) but a CO/CH₄ separation will not make it possible to remove the argon effectively, the latter being lighter than methane.

The CO/Ar binary mixture is as complicated to separate as the CO/N₂ binary mixture because these are molecules having very similar physical properties. In this specific case, CO is virtually equidistant between N₂ and Ar:
Boiling point of N₂ at Pₐₜₘ=−195.8° C.
Boiling point of CO at Pₐₜₘ=−191.5° C.
Boiling point of Ar at Pₐₜₘ=−185.85° C.

Thus, only the “cryogenic distillation column” technology can make it possible to achieve, at acceptable costs, very low levels of nitrogen and argon impurities in CO. On the other hand, little information is available on the CO/Ar and CO/N₂ binary mixtures at these purity levels, which complicates the dimensioning of such a distillation column.

One solution proposed is a double distillation column composed:
of a first distillation column, which makes it possible to remove the nitrogen and, if they are present, all the other components lighter than CO,
of a second distillation column, which makes it possible to remove the argon and, if they are present, all the other components heavier than CO.

Alternatively, the heavier component(s) can be removed first in a first column and subsequently the lighter component(s) can be removed.

In both cases, the two columns are preferably assembled one above the other and are connected thermally by a heat exchanger. This exchanger is the reboiler of the upper column and the condenser of the lower column. The first column is also equipped with a reboiler at the bottom (“main reboiler”) making it possible to create a liquid/vapour reflux sufficient to distil the impurities to the purity level demanded. The second column is equipped with a top condenser, located at its summit, to condense said reflux.

The columns can be placed without distinction in the desired order: purification of nitrogen and then of argon, or vice versa. In a conventional distillation column having a top vaporizer, it is possible to separate a light constituent (in this instance CO) from a heavy constituent (in this instance argon). In the absence of a bottom reboiler, the feed flow entering the bottom contaminates the liquid, which is removed from the bottom, polluting it and reducing the purity. Thus, success is not achieved in extracting all the CO from the feed flow into the top gas of the column. This phenomenon is aggravated when the two constituents have similar thermodynamic characteristics, which is the case here.

When it is desired to produce a given amount of pure carbon monoxide, a large amount of vapour flow circulating in the column is needed, which also causes a large amount of falling liquid.

In order to obtain the large vapour flow rate, a bottom reboiler is added at the bottom of the column, in order to increase the vapour flow rate without increasing the feed flow rate.

The vapour circulating in the column is thus increased and makes it possible to recycle a large part of the falling liquid in the column. The withdrawal of liquid at the bottom of the column can be low.

The process can be improved by adding theoretical plates between the reboiler and the point of arrival of the feed flow and by withdrawing the liquid from the reboiler rather than from the bottom of the column.

Optional characteristics (some of them can be combined):
The solution developed has a production molar flow rate/boiling molar flow rate ratio of between 8% and 25%;
The production molar flow rate is the flow rate of carbon monoxide purified in argon and in nitrogen and the boiling molar flow rate is the amount of gas produced by the bottom reboiler of the lowest column of the double column used;
The double column forms a total height of less than 30 m;
The distillation columns operate at less than 5 bara, which makes it possible to avoid the use of a compressor: the mixture at the plant inlet is directly reduced in pressure from a pressurized storage tank;
The fluid purified in the first column and feeding the second column is withdrawn in the gas phase. Withdrawal in the liquid phase would be liable to create operational instabilities, due to the small difference in operating pressure between the two columns;

1The main reboiler is outside the column, thus making it possible to limit the overall height of the double distillation column;
The main reboiler comprises a heat exchanger (for example an immersed pipe) making it possible to cool and liquefy, at least partially, the CO at the plant inlet and to reduce the power of the main exchanger of the reboiler;
The main reboiler can comprise, as heat source, one or more electrical heaters;
The top condenser is fed with liquid nitrogen; and/or
The double column is preceded by one or more adsorbers making it possible to remove impurities, such as CO₂ or water;

For example, a distillation column can be developed to achieve these purities with the following conditions:
Production flow rate to boiling flow rate ratio=12.5%;
Distillation column 26 m in height;
Yield of 75% or better.

In one example:
Impurities, such as hydrogen, oxygen and methane, can also be removed from the CO;
It was decided to place the denitrogenation column below the deargonization column;
The main reboiler was offset;
The main reboiler consists of an exchanger (immersed pipe) in order to cool and liquefy the CO upstream of the denitrogenation column and of an electrical heater;
The top condenser is fed with liquid nitrogen;
The top condenser and the intercolumn condenser are plate exchangers;

### Advantages of Certain Embodiments of the Invention

Certain embodiments of the invention make it possible to achieve CO purities not achievable by virtue of a simple denitrogenation and/or demethanization column, which are two types of CO purification columns.

The use of a double distillation column, the two parts being placed one above the other, makes it possible not to use machines (pumps), which increases the reliability of the factory.

The ratio of the flow rates that is proposed originates from the optimization of the operating conditions. This is because the conventional equations of state for CO/N₂/Ar mixtures do not make it possible to obtain exact results for the level of purity required. The development of a specific equation of state for this mixture makes it possible to precisely dimension the distillation columns and thus to optimize the operating conditions: temperatures, pressures, reflux flow rate, consumption of utilities, height of the column and yield of the distillation columns. The reflux flow rate and the consumption of the utilities are directly related. By limiting the reflux to the flow rate strictly necessary, less liquid nitrogen and less electricity are consumed.

Furthermore, by limiting the height of the distillation columns (by reducing the number of theoretical or real plates), the transportation of the plant and the complexity of the mechanical manufacture are rendered easier and thus the cost of the plant is reduced.

According to a subject-matter of the invention, provision is made for a process for the purification of a first feed flow containing at least 97% mol of carbon monoxide containing at least one lighter component and at least one heavier component, in which:

i) the first feed flow is cooled, in order to produce a cooled feed flow, and the cooled feed flow is sent to a first column operating at less than 5 bar, where it is separated by distillation to form the top gas, enriched in the lighter component, and a bottom liquid, enriched in the heavier component,

ii) at least a part of the bottom liquid is at least partially vaporized by indirect heat exchange with the first feed flow in order to cool it according to stage i) and by at least one electrical heater and at least a part of the at least partially vaporized liquid is sent to the first column,

iii) a second feed flow is sent from the first column to an intermediate level of a second column, which second feed flow consists of:

a) at least a part of the vaporized bottom liquid or

b) at least a part of a gas withdrawn at the top of the first column,

iv) the second feed flow is separated in the second column to form a top gas of the column and a bottom fluid of the second column and

a′) if the second feed flow consists of the at least a part of the vaporized bottom liquid, a liquid enriched in the heavier component is withdrawn at the bottom of the second column and a gaseous product is withdrawn at the top of the second column or

b′) if the second feed flow consists of the at least a part of a gas withdrawn at the top of the first column, a gaseous product is withdrawn at the bottom of the second column and a gaseous product enriched in the lighter component is withdrawn at the top of the second column and

v) the gaseous product contains at least 99% mol of carbon monoxide and less of the lighter component and of the heavier component, for example nitrogen and argon, than the first feed flow,

the ratio of the flow rate of gaseous product to the flow rate of vaporized bottom liquid of stage ii) being between 8 mol % and 25 mol %.

According to other optional aspects:
the main lighter component is nitrogen,
the main heavier component is argon,
the gaseous product of the second column contains at least 99.99% mol or at least 99.999% mol, indeed even at least 99.9999% mol, of carbon monoxide,
the first feed flow contains at least 99% mol of carbon monoxide,
the gaseous product contains less than 2 ppm, indeed even less than 0.5 ppm, of nitrogen,
the gaseous product contains less than 2 ppm, indeed even less than 0.5 ppm, of argon,
the first pressure is less than 5 bar abs,
the feed flow is reduced in pressure upstream of the first column,
the feed flow is used to at least partially vaporize at least a part of the bottom liquid,
the first feed flow is at least partially condensed by heat exchange with the bottom liquid,
the at least one electrical heater is used to contribute at least 55%, indeed even at least 65%, of the heat necessary to vaporize the at least a part of the bottom liquid,
the at least one electrical heater is used to contribute between at least 55% and 85%, indeed even between at least 65% and 72%, of the heat necessary to vaporize the at least a part of the bottom liquid,
the difference in pressure between the first and the second column is less than 2 bar, indeed even than 1.8 bar,
a top condenser of the second column is cooled by a refrigerant originating from an external source, for example liquid nitrogen,
the feed flow also contains hydrogen and/or oxygen and/or methane,
the feed flow is purified in water and/or in carbon dioxide upstream of the first column,
according to the alternative form a) a′), liquid is not sent from the top of the first column to the top of the second column,
according to the alternative form b) b′), vaporized bottom liquid is not sent to the second column,
bottom liquid is not sent from the first column to the second column in the liquid form,
bottom liquid is not sent from the first column to the second column,
top liquid is not sent from the first column to the second column,
liquid is not sent from the second column to the first column,
the bottom liquid flow is withdrawn from the column and sent to a reboiler, where it is partially vaporized by the first feed flow and the at least one electrical heater,
The double column is at least 20 m high; and/or
a liquid flow is withdrawn from the reboiler, constituting preferably a final product or a bleed.

According to another subject-matter of the invention, provision is made for an apparatus for the purification of a first feed flow containing at least 97% mol of carbon monoxide containing at least one lighter component and at least one heavier component comprising a first column and a second column, means for cooling the first feed flow in order to produce a cooled feed flow, an electrical heater for heating the at least a part of the bottom liquid, means for sending the cooled feed flow to the first column in order to be separated by distillation to form the top gas enriched in the lighter component and a bottom liquid enriched in the heavier component, the means for cooling the first feed flow making possible an indirect heat exchange between the first feed flow and at least a part of the bottom liquid which is at least partially vaporized, means for sending at least a part of the at least partially vaporized liquid to the first column, means for sending a second feed flow from the first column to an intermediate level of the second column, which second feed flow consists of:

i) at least a part of the vaporized bottom liquid; or

ii) at least a part of a gas withdrawn at the top of the first column; the second column being suitable for separating the second feed flow in order to form a top gas of the column and a bottom gas of the second column; and

a′) if the second feed flow consists of the at least a part of the vaporized bottom liquid, means for withdrawing a liquid enriched in the heavier component at the bottom of the second column and means for withdrawing a gaseous product at the top of the second column; or

b′) if the second feed flow consists of the at least a part of a gas withdrawn at the top of the first column, means for withdrawing a gaseous product at the bottom of the second column and means for withdrawing a gas enriched in the lighter component at the top of the second column; and

the gaseous product containing at least 99% mol of carbon monoxide and less of the lighter component and of the heavier component, for example nitrogen and argon, than the first feed flow.

According to other optional aspects:
the top of the first column is thermally connected to the second column,
a bottom reboiler of the second column is connected in order to condense a top gas of the first column,
the first and second columns constitute a double column, the second column being above the first column,
the total height of the combined first and second columns is less than 30 m,
the means for cooling the first feed flow consist of a reboiler, preferably located outside any column,
the reboiler comprises means for exiting a bleed liquid,
the apparatus comprises means for cooling the top of the second column by indirect heat exchange, by sending there preferably a refrigerant from an external source,
the apparatus comprises a reboiler outside any column containing the means for cooling the first flow and the at least one electrical heater and means for sending the bottom liquid to the reboiler, and/or
the appliance comprises means for withdrawing unvaporized bottom liquid from the reboiler.

### BRIEF DESCRIPTION OF THE DRAWINGS

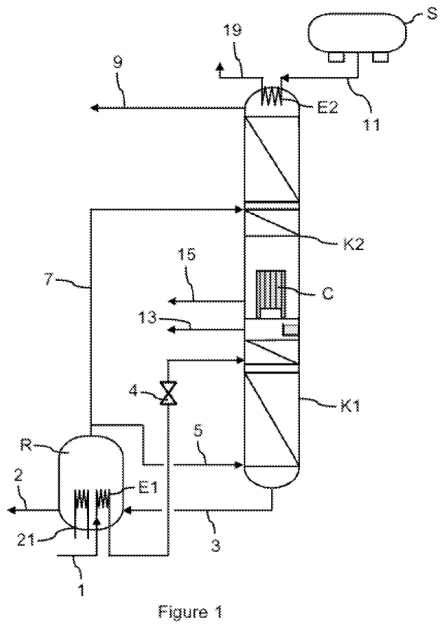

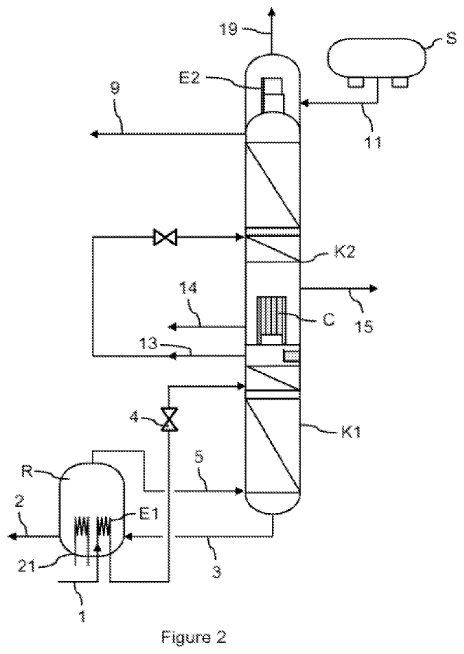

Further features and advantages of the invention will become apparent from the description hereinafter of embodiments, which are given by way of illustration but without any limitation, the description being given in relation with the following attached figures:

[FIG. 1] illustrates a process according to the invention.

[FIG. 2] illustrates a process according to the invention.

### DETAILED DESCRIPTION OF THE INVENTION

The apparatus of [FIG. 1] comprises a first distillation column K1 operating at a first pressure and a second column K2 operating at a second pressure lower than the first pressure. The first pressure is preferably less than 5 bar abs; for example, the first pressure can be 3.5 bar abs and the second pressure 1.8 bar abs. The first column is at a temperature between 92 and 93K and the second column between 87 and 88K.

The first and second columns K1, K2 comprise structured packings in order to promote the exchange of mass and of heat in the column, thus making possible the distillation.

The first column K1 is used to remove the nitrogen and the second K2 the argon in a flow 1 containing at least 97% mol of carbon monoxide.

The second column K2 comprises, at the bottom, a first reboiler C connected in order to condense a top gas of the first column K1 and in order to heat a bottom liquid of the second column and, at the top, a condenser E2. The condenser E2 is cooled by a flow of liquid nitrogen 11 originating from a storage tank S which transfers heat indirectly at the top of the column, thus vaporizing the liquid nitrogen.

The feed flow can be provided from a gas storage tank or a lorry transporting gas cylinders containing relatively impure carbon monoxide. This gas is reduced in pressure in order to arrive at a pressure of 7 bar abs and subsequently is sent as flow 1 to the heat exchanger E1 of a second reboiler R. This bottom reboiler R is used to feed the bottom of the first column K1 with vapour and to provide the feed gas to the second column K2. It is positioned beside the column K1 in order to reduce the total height of the combined columns K1, K2 but can be incorporated in the column K1.

The gas 1 can contain at least 97% of carbon monoxide (or at least 99% of carbon monoxide) and also argon and nitrogen. It can also contain oxygen and/or methane and/or hydrogen.

If it contains water and/or carbon dioxide, these impurities are removed by adsorption or by deposition as described in WO18111719 upstream of the reboiler R.

The gas 1 enters the heat exchanger El at a temperature close to ambient temperature and with a flow rate of approximately 50 Nm³/h. It is condensed in E1, reduced in pressure down to 3.8 bar in the valve 4 and sent to an intermediate level of the first column in a two-phase form. It is separated by distillation and, at the bottom of the column, there is found a bottom liquid depleted in nitrogen which is sent, at least in part, as flow 3 to the reboiler R, where it is vaporized. Since the feed gas 1 is not sufficient to vaporize the flow 3, at least one electrical heater 21 also provides heat. Generally, two thirds of the vaporization heat are provided in this way.

The vaporized gas is divided into two, one part 5 being sent into the bottom of the first column K1 and the other part 7 being sent to an intermediate level of the second column K2 as sole feed flow.

A part 2 of the bottom liquid can be bled off.

A gas enriched in nitrogen 13 is withdrawn at the top of the first column K1.

A gas 9 is withdrawn at the top of the second column K2 containing at least 99.99% mol or at least 99.999% mol, indeed even at least 99.9999% mol, of carbon monoxide and the fluid 15 enriched in argon, which can be gaseous or liquid, is withdrawn at the bottom of the second column K2.

The flows 2, 13, 15 are sent to a scrubbing tower or another conversion or inerting plant because of their high content of carbon monoxide.

The product 9 can be heated by a heater, if the client desires it, to a higher temperature than that of the second column K2.

Liquid is not sent from the top of the first column K1 to the top of the second column K2.

No part of the bottom liquid from the first column K1 is sent in the liquid form to the second column K2.

The ratio of the production flow rate 9 to the boiling flow rate 5 plus 7 is between 8% and 25%.

The production flow rate is the flow rate of carbon monoxide 9 purified in argon and in nitrogen and the boiling flow rate is the amount of gas 5 plus 7 produced by the bottom reboiler of the lowest column of the double column used.

[FIG. 2] shows the alternative where the argon is removed in the first column K1 and the nitrogen in the second K2.

The apparatus of [FIG. 2] comprises a first distillation column K1 operating at a first pressure and a second column K2 operating at a second pressure lower than the first pressure. The first pressure is preferably less than 5 bar abs; for example, the first pressure can be 3.5 bar abs and the second pressure 1.8 bar abs. The first column is at a temperature between 92 and 93K and the second column between 87 and 88K.

The first and second columns K1, K2 comprise structured packings in order to promote the exchange of mass and of heat in the column, thus making possible the distillation.

The first column K1 is used to remove the argon and the second the nitrogen.

The second column K2 comprises, at the bottom, a first reboiler C connected in order to condense a top gas of the first column K1 and to feed the bottom of the second column with vapour and, at the top, a condenser E2. The condenser E2 is cooled by a flow of liquid nitrogen 11 originating from a storage tank S which transfers heat indirectly at the top of the column, thus vaporizing the liquid nitrogen to form a gas 19.

The feed flow can be provided from a gas storage tank or a lorry transporting gas cylinders containing relatively impure carbon monoxide. This gas is reduced in pressure by Joule-Thomson pressure reduction in order to arrive at a pressure of 7 bar abs and subsequently is sent as flow 1 to the heat exchanger E1 of a second reboiler R. This bottom reboiler R is used to provide gas to the bottom of the first column. It is positioned beside the column K1 in order to reduce the total height of the combined columns K1, K2 but can be incorporated in the column K1 .

The gas 1 can contain at least 97% of carbon monoxide (or at least 99% of carbon monoxide) and also argon and nitrogen. It can also contain oxygen and/or methane and/or hydrogen.

If it contains water and/or carbon dioxide, these impurities are removed by adsorption or by deposition, as in WO18111719, upstream of the reboiler R.

The gas 1 enters the heat exchanger El at a temperature close to ambient temperature and with a flow rate of approximately 50 Nm³/h. It is condensed in E1, reduced in pressure down to 3.8 bar in the valve 4 and sent to an intermediate level of the first column in a two-phase form. It is separated by distillation and, at the bottom of the column K1, there is found a bottom liquid enriched in argon which is sent, at least in part, as flow 3 to the reboiler R, where it is vaporized. Since the feed gas 1 is not sufficient to vaporize the flow 3, at least one electrical heater 21 provides heat. Generally, two thirds of the vaporization heat are provided in this way. For example, the electrical heater 21 can contribute between at least 55% and 85%, indeed even between at least 65% and 72%, of the heat necessary to vaporize the at least a part of the bottom liquid.

The vaporized gas 5 enriched in argon is sent into the bottom of the first column K1.

A liquid 2 withdrawn from the second reboiler R is bled off.

A gas depleted in argon 13 is withdrawn at the top of the first column K1, reduced in pressure in a valve and sent to an intermediate level of the column K2 as sole feed flow.

A gas 9 enriched in nitrogen is withdrawn at the top of the second column K2 and the gaseous product 15 depleted in nitrogen is withdrawn at the bottom of the second column K2 containing at least 99.99% mol or at least 99.999% mol, indeed even at least 99.9999% mol, of carbon monoxide. A liquid 14 makes it possible to bleed the bottom of the second column K2 when necessary.

The flows 2, 9, 14 are sent to a scrubbing or inerting tower because of their high content of carbon monoxide.

The product 15 can be heated by a heater, if the client desires it, to a higher temperature than that of the second column K2.

No part of the bottom liquid 3 enriched in argon is sent to the second column K2.

The ratio of the production flow rate to the boiling flow rate is between 8% and 25%.

The production flow rate is the flow rate of carbon monoxide 15 purified in argon and in nitrogen and the boiling flow rate is the amount of gas 5 produced by the bottom reboiler of the lowest column of the double column used.

In the examples, the lighter component is nitrogen and the heavier component is argon but other compositions are possible.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A process for the purification of a first feed flow comprising at least 97% mol of carbon monoxide, a lighter component, and a heavier component, the process comprising the steps of:
a) cooling the first feed flow thereby producing a cooled feed flow, and then sending the cooled feed flow to a first column operating at less than 5 bar, wherein the cooled feed flow is separated by distillation to form a top gas, which is enriched in the lighter component, and a bottom liquid, which is enriched in the heavier component;
b) at least partially vaporizing at least a part of the bottom liquid by (1) indirect heat exchange with the first feed flow thereby cooling the first feed flow according to step a) and (2) at least one electrical heater, and then sending at least a part of the at least partially vaporized liquid to the first column,
c) sending a second feed flow from the first column to an intermediate level of a second column, wherein the second feed flow comprises:
i. at least a part of the vaporized bottom liquid or
ii. at least a part of a gas withdrawn at the top of the first column,
d) separating the second feed flow in the second column to form a top gas of the second column and a bottom fluid of the second column;
wherein:
e(i) if the second feed flow comprises the at least a part of the vaporized bottom liquid, a liquid enriched in the heavier component is withdrawn at the bottom of the second column and a gaseous product is withdrawn at the top of the second column, or
e(ii) if the second feed flow comprises the at least a part of a gas withdrawn at the top of the first column, a gaseous product is withdrawn at the bottom of the second column and a gaseous product enriched in the lighter component is withdrawn at the top of the second column; and
wherein the gaseous product contains at least 99% mol of carbon monoxide and less nitrogen and argon than the first feed flow, and the ratio of the flow rate of gaseous product to the flow rate of vaporized bottom liquid of stage ii) being between 8 mol % and 25 mol %.

2. The process according to claim 1, wherein the gaseous product of the second column contains at least 99.99% mol of carbon monoxide.

3. The process according to claim 1, wherein the first feed flow contains at least 99% mol of carbon monoxide.

4. The process according to claim 1, wherein the gaseous product contains less than 2 ppm of nitrogen.

5. The process according to claim 1, wherein the gaseous product contains less than 2 ppm of argon.

6. The process according to claim 1, wherein the bottom liquid flow is withdrawn from the column and sent to a reboiler, where the bottom liquid flow is partially vaporized by the first feed flow and the at least one electrical heater.

6. cess according to claim 6, wherein a liquid flow is withdrawn from the reboiler.

8. The process according to claim 1, wherein the feed flow is reduced in pressure upstream of the first column.

9. The process according to claim 1, wherein the first feed flow is at least partially condensed by heat exchange with the bottom liquid.

10. The process according to claim 1, wherein the at least one electrical heater is used to contribute at least 55% of the heat necessary to vaporize the at least a part of the bottom liquid.

11. The process according to claim 1, wherein the pressure difference between the first and the second columns is less than 2 bar.

12. The process according to claim 1, wherein a top condenser of the second column is cooled by a refrigerant originating from an external source.

13. The process according to claim 1, wherein the feed flow is purified in water and/or in carbon dioxide upstream of the first column.

14. An apparatus for the purification of a first feed flow containing at least 97% mol of carbon monoxide containing at least one lighter component and at least one heavier component, the apparatus comprising:
a first column and a second column;
means for cooling the first feed flow in order to produce a cooled feed flow;
means for sending the cooled feed flow to the first column in order to be separated by distillation to form the top gas enriched in the lighter component and a bottom liquid enriched in the heavier component;
wherein the means for cooling the first feed flow is configured to provide an indirect heat exchange between the first feed flow and at least a part of the bottom liquid which is at least partially vaporized;
at least one electrical heater configured to heat the at least a part of the bottom liquid;
means for sending at least a part of the at least partially vaporized liquid to the first column;
means for sending a second feed flow from the first column to an intermediate level of the second column;
wherein the second feed flow consists of:
at least a part of the vaporized bottom liquid, or
at least a part of a gas withdrawn at the top of the first column,
wherein the second column is configured to separate the second feed flow in order to form a top gas of the column and a bottom fluid of the second column; and
wherein:
a) if the second feed flow consists of the at least a part of the vaporized bottom liquid, the apparatus comprises means for withdrawing a liquid enriched in the heavier component at the bottom of the second column and means for withdrawing a gaseous product at the top of the second column; or
b) if the second feed flow consists of the at least a part of a gas withdrawn at the top of the first column, the apparatus comprises means for withdrawing a gaseous product at the bottom of the second column and means for withdrawing a gaseous product enriched in the lighter component at the top of the second column,
wherein the gaseous product contains at least 99% mol of carbon monoxide and reduced amounts of the lighter component and of the heavier component as compared to the first feed flow.

15. The apparatus according to claim 14, comprising a reboiler outside any column containing the means for cooling the first flow and the at least one electrical heater, and means for sending the bottom liquid to the reboiler.
